(19) United States
(12) Patent Application Publication
(10) Pub. No.: US 2015/0295686 A1
(43) Pub. Date: Oct. 15, 2015

(54) METHOD FOR CONFIGURING REFERENCE SIGNAL RESOURCES FOR COOPERATIVE MULTIPOINT TRANSMISSION

(71) Applicant: ALCATEL LUCENT, Paris (FR)

(72) Inventors: Yun Deng, Shanghai (CN); Zhilan Xiong, Shanghai (CN); Min Zhang, Swindon (GB)

(73) Assignee: Alcatel Lucent, Boulogne Billancourt (FR)

(21) Appl. No.: 14/441,229

(22) PCT Filed: Nov. 6, 2013
(86) PCT No.: PCT/IB2013/002721

§ 371 Date: May 7, 2015

(30) Foreign Application Priority Data
Nov. 7, 2012 (CN) 201210442289.3

(51) Int. Cl. H04L 5/00; H04W 72/04

(52) U.S. Cl. CPC H04L 5/0035; H04W 72/0406; H04L 5/0053

(57) ABSTRACT

The present invention relates to Coordinated Multiple Point (CoMP) transmission. According to an embodiment, a method for a serving base station of CoMP transmission includes sending a message to a cooperating base station of the CoMP transmission to indicate desired Non-Zero-Power Channel Status Information Reference Signal (NZP CSI RS) resources and/or Zero-Power Channel Status Information Reference Signal (ZP CSI RS) resources. The method meets new needs and facilitates CoMP transmission.

### BACKGROUND OF THE INVENTION

1. Field of the Invention

The present invention relates to mobile communication and, in particular, to Coordinated Multiple Point (CoMP) transmission.

2. Description of the Prior Art

In modern mobile communication systems such as Long Term Evolution (LTE) projects, a base station determines transmission formats, the size of transmission blocks, modulation and coding schemes, Multiple Input Multiple Output (MIMO) transmission modes, and the like for downlink (DL) and uplink (UL). To enable determination for the DL, the bases station needs information about performance of the current DL channel from a User Equipment (UE), which is generally referred to as Channel State Information (CSI).

Frequency Division Multiplexing (FDM) CoMP transmission has the potential of improving cell edge user throughput and even improving cell average throughput, depending on whether to share CSI and/or user data between coordinated cells. Further, CoMP can be classified as Coordinated Scheduling/Coordinated Beamforming (CSCB), Dynamic Point Selection (DPS), Dynamic Point Blanking (DPB) and Joint Transmission (JT).

Diversity of the transmission modes in the CoMP means that a UE may face a number of interference hypotheses, and thus interference measurement is necessary for the CoMP. Due to introduction of the Interference Measurement Resource (IMR), the traditional resource configuration mode is no longer competent. For example, in existing techniques there are no feasible schemes for determining, through negotiation between base stations, configuration of IMRs for UEs.

### SUMMARY OF THE INVENTION

An objective of the present invention is to achieve CoMP transmission and overcome the above defect in prior art.

An embodiment of the present invention provides a method for a serving base station of CoMP transmission, including sending a message to a cooperating base station of the CoMP transmission to indicate desired Non-Zero-Power Channel Status Information Reference Signal (NZP CSI RS) resources and/or Zero-Power Channel Status Information Reference Signal (ZP CSI RS) resources.

Another embodiment of the present invention provides a method for a cooperating base station of CoMP transmission, including sending a message to the serving base station to indicate NZP CSI RS resources and/or ZP CSI RS resources of the cooperating base station.

A yet another embodiment of the present invention provides a method for a base station of CoMP transmission, including broadcasting NZP CSI RS resources in a Cooperating Set of the CoMP transmission.

The above-mentioned technical features and advantages of the present invention will be better understood by the following detailed description. Other features and advantages of the present invention will be described in the following text, which constitute the subject matter of the claims of the present invention. Persons skilled in the art should understand that, concepts and embodiments disclosed can be easily used as the basis of amending or designing other structures or processes for achieving an objective identical to that of the present invention. Persons skilled in the art also should understand that, such equivalent construction does not depart from the spirit and scope of the appended claims.

### BRIEF DESCRIPTION OF THE DRAWINGS

It will be much easier to understand the following detailed description about preferred embodiments of the present invention with reference to the accompanying drawings. The present invention is described by way of example and is not limited to the accompanying drawings, and similar reference signs in the accompanying drawings indicate similar elements.

FIG. 1 is a schematic diagram of a CoMP transmission system architecture according to an embodiment of the present invention;

FIG. 2 is a flow diagram showing a method for CoMP transmission that involves a serving base station and a cooperating base station according to an embodiment of the present invention;

FIG. 3 is a flow diagram showing a method for CoMP transmission that involves a serving base station and a cooperating base station according to another embodiment of the present invention;

FIG. 4 is a flow diagram showing a method for CoMP transmission that involves a serving base station and a cooperating base station according to a yet another embodiment of the present invention; and

FIG. 5 is a flow diagram showing a method for CoMP transmission that involves a serving base station and a cooperating base station according to a further embodiment of the present invention.

### DETAILED DESCRIPTION

Detailed description about the accompanying drawings intends to serve as description about current preferred embodiments of the present invention, instead of representing only forms in which the present invention could be achieved. It should be understood that the same or equivalent functions can be accomplished by different embodiments intending to be contained in the spirit and scope of the present invention.

Persons skilled in the art should understand that, the means and functions described herein can be implemented by using a combination of software functions of a programmable microprocessor and a general-purpose computer, and/or be implemented by using an application specific integrated circuit (ASIC). Persons skilled in the art also should understand that, although the present invention is described mainly in the form of methods and devices, the present invention also can be embodied as a computer program product and a system including a computer processor and a memory coupled to the processor, where the memory is coded with one or more programs which can accomplish the functions disclosed herein.

Persons skilled in the art should understand that, the base station has different technical terms in different protocol standards. For example, the base station is referred to as Node B or an evolved Node B (eNB) in an LTE system or an LTE-A system. The base station referred to in the present invention is, for example, but not limited to, the eNB in the LTE-A system. The methods and devices provided in the present invention are applied to, for example, but not limited to, the LTE system.

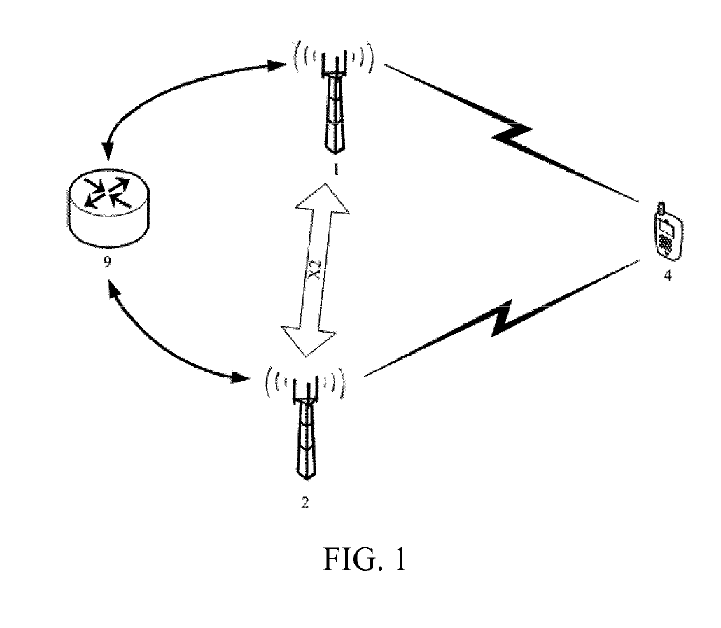

FIG. 1 is a schematic diagram of a CoMP transmission system architecture according to an embodiment of the present invention. FIG. 1 shows base stations 1 and 2 and a user terminal 4. The base stations 1 and 2 jointly perform CoMP transmission for the user terminal 4 or the user terminal 4 performs CoMP transmission for another user terminal, where the base station 1 serves as a serving base station of the user terminal 4, and the base station 2 serves as a cooperating base station. The base stations 1 and 2 exchange information via a backhaul network or an X2 interface. It should be understood that, multiple base stations may be configured for the same site, for example, three base stations respectively serve a sector of 120°; the base stations in the site do not need to exchange information via a backhaul network or an X2 interface, and the base stations needing to exchange information via a backhaul network or an X2 interface are usually base stations in different sites.

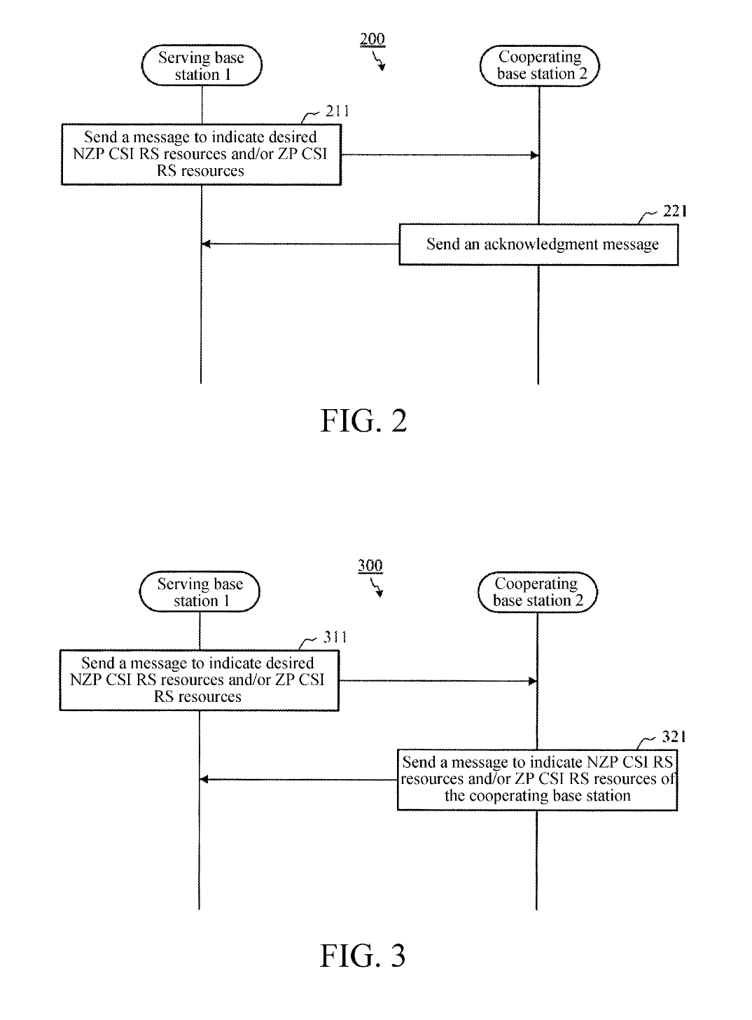

FIG. 2 is a flow diagram showing a method 200 for CoMP transmission that involves a serving base station 1 and a cooperating base station 2 according to an embodiment of the present invention. The method 200 includes step 211 at the serving base station 1 and step 221 at the cooperating base station 2.

In step 211, the serving base station 1 sends a message to the cooperating base station 2 to indicate desired NZP CSI RS resources and/or ZP CSI RS resources. The message may indicate at least two NZP CSI RS resources.

When the message sent in step 211 is used to indicate the desired NZP CSI RS resources, the message usually includes resource configuration (resourceConfig) information and subframe configuration (subframeConfig) information.

Optionally, the message sent in step 211 may further include cell identification information and/or antenna port configuration information about the NZP CSI RS resources of the serving base station 1. The cell identification information is for example, but not limited to, a virtual cell ID. If the virtual cell ID of the serving base station 1 adopts a default value, the message does not necessarily include the virtual cell ID. If the cooperating base station 2 has known the antenna port configuration information about the serving base station 1 in advance, such information may be omitted in the message.

Optionally, the message sent in step 211 further includes effective time of the configuration information about the NZP CSI RS resources. If the effective time is not defined, the cooperating base station 2 will regard resources requested or indicated by the serving base station 1 as being effective at all times, until the request or indication is updated next time.

After successfully receiving and accepting the configuration information from the serving base station 1, the cooperating base station 2 returns an acknowledgment (Ack) message in step 221.

If the serving base station 1 receives the acknowledgment message from the cooperating base station 2, the serving base station 1 performs configuration according to the desired NZP CSI RS resources, and updates a CoMP Measurement Set correspondingly, and the updated CoMP Measurement Set can be notified to the user terminal 4 via Radio Resource Control (RRC) layer signaling. After obtaining the CoMP Measurement Set, the user terminal 4 evaluates and reports corresponding CSI according to the Measurement Set, and the serving base station 1 can thus adopt an appropriate transmission mode in CoMP for the user terminal 4 and utilize multiple points to serve the user terminal, so as to achieve the aim of eliminating interference and enhancing throughput.

If the serving base station 1 does not receive the acknowledgment message from the cooperating base station 2 within a predetermined time or receives a receive failure message from the cooperating base station 2, the serving base station 1 can re-send the message sent in step 211.

When the message sent in step 211 is used to indicate the desired ZP CSI RS resources, the message usually includes resource configuration information (for example, represented as zeroTxPowerResourceConfigList) and subframe configuration information (for example, represented as zeroTxPowerSubframeConfig).

Optionally, the message sent in step 211 may further include cell identification information about the ZP CSI RS resources of the serving base station 1, which is for example, but not limited to, a cell ID and a virtual cell ID. Alternatively, the cell identification information about the ZP CSI RS resources also may be associated with the cell identification information about the NZP CSI RS resources and thus be uniquely determined, so that the cell identification information about the ZP CSI RS resources can be omitted.

Optionally, the message sent in step 211 further includes effective time of the configuration information about the ZP CSI RS resources. If the effective time is not defined, the cooperating base station 2 will regard resources requested or indicated by the serving base station 1 as being effective at all times, until the request or indication is updated next time.

After successfully receiving and accepting the configuration information from the serving base station 1, the cooperating base station 2 returns an acknowledgment (Ack) message in step 221.

If the serving base station 1 receives the acknowledgment message from the cooperating base station 2, the serving base station 1 performs configuration according to the desired ZP CSI RS resources, and updates a CoMP Measurement Set correspondingly, and the updated CoMP Measurement Set can be notified to the user terminal 4 via RRC signaling.

If the serving base station 1 does not receive the acknowledgment message from the cooperating base station 2 within a predetermined time or receives a receive failure message from the cooperating base station 2, the serving base station 1 can re-send the message sent in step 211.

The serving base station 1 can use at least part of available ZP CSI RS resources as IMRs, and updates the CoMP Measurement Set correspondingly, and the updated CoMP Measurement Set can be notified to the user terminal 4 via RRC signaling.

When the message sent in step 211 is used to indicate the desired ZP CSI RS resources, the message optionally further includes information used to indicate IMR configuration, and the information may correspond to different interference hypotheses. Table 1 gives such a configuration.

TABLE 1
IMR Index Configuration Table

| IMR Index | CSI RS resources belonging to | CSI RS resources belonging to |
|---|---|---|
| No. | the serving base station 1 | the cooperating base station 2 |
| 1 | ZP CSI RS | ZP CSI RS |
| 2 | ZP CSI RS | PDSCH |
| 3 | PDSCH | ZP CSI RS |

The IMR Index No. 1 corresponds to the interference hypothesis of DPB, and the two CSI RS resources indicated respectively belong to the ZP CSI RS resource of the serving base station 1 and the ZP CSI RS resource of the cooperating base station 2; the IMR Index No. 2 corresponds to the interference hypothesis of CSCB or DPS, and the two CSI RS resources indicated respectively belong to the ZP CSI RS resource of the serving base station 1 and the Physical Downlink Shared Channel (PDSCH) resource of the cooperating base station 2 (at this time, the cooperating base station 2 does not configure ZP CSI RS on a resource particle RE corresponding to the ZP CSI RS of the serving base station 1, and PDSCH for transmitting data is on the resource particle); the IMR Index No. 3 corresponds to the interference hypothesis of DPS, and the two CSI RS resources indicated respectively belong to the PDSCH resource of the serving base station 1 and the ZP CSI RS resource of the cooperating base station 2 (at this time, the serving base station 1 does not configure ZP CSI RS on a resource particle RE corresponding to the ZP CSI RS of the cooperating base station 2, and PDSCH for transmitting data is on the resource particle). Persons skilled in the art should understand that, the corresponding relations between the CSI RS resource configuration and the IMR indexes in Table 1 are only exemplary instead of being restrictive. In some other embodiments, there may be three or more than three interference hypotheses corresponding to the IMR index numbers, there may be more than two CSI RS resources configured for each interference hypothesis, and the numbers of the CSI RS resources configured for each interference hypothesis may be the same or different. For example, when CoMP transmission involves three or more base stations, usually more interference hypotheses and allocation of more CSI RS resources are required.

The messages from the serving base station 1 used to indicate the desired NZP CSI RS resources and indicate the desired ZP CSI RS resources (which may include IMR) can be sent separately, or be combined in one message and sent together. Correspondingly, reply messages from the cooperating base station 2 may be sent separately or combined in one message and sent together.

FIG. 3 is a flow diagram showing a method 300 for CoMP transmission that involves a serving base station 1 and a cooperating base station 2 according to an embodiment of the present invention. The method 300 includes step 311 at the serving base station 1 and step 321 at the cooperating base station 2.

In step 311, the serving base station 1 sends a message to the cooperating base station 2 to indicate desired NZP CSI RS resources and/or ZP CSI RS resources. The message may indicate at least two NZP CSI RS resources.

Step 311 is similar to step 211 in the previous method 200, where when the message sent is used to indicate the desired NZP CSI RS resources, and the message usually includes resource configuration (resourceConfig) information and subframe configuration (subframeConfig) information. Optionally, the message further includes cell identification information and/or antenna port configuration information about the serving base station 1. Optionally, the message further includes effective time of the configuration information about the NZP CSI RS resources.

After receiving the configuration information from the serving base station 1, the cooperating base station 2 can select more suitable resources for the NZP CSI RS according to its own condition. Then, in step 321, a message is sent to the serving base station 1 to indicate NZP CSI RS resources and/or ZP CSI RS resources of the cooperating base station 2.

When receiving the message from the cooperating base station 2 indicating the NZP CSI RS resources and/or the ZP CSI RS resources of the cooperating base station 2, the serving base station 1 correspondingly updates a CoMP Measurement Set, and the updated CoMP Measurement Set can be notified to the user terminal 4 via RRC layer signaling.

Optionally, the message sent in step 321 may further include cell identification information and/or antenna port configuration information about the cooperating base station 2. The cell identification information is for example, but not limited to, a virtual cell ID. If the virtual cell ID of the cooperating base station 2 adopts a default value, the message does not necessarily include the virtual cell ID. If the serving base station 1 has known the antenna port configuration information about the cooperating base station 2 in advance, such information may be omitted in the message.

Optionally, the message sent in step 321 further includes effective time of the configuration information about the NZP CSI RS resources of the cooperating base station 2.

When the message sent in step 311 is used to indicate the desired ZP CSI RS resources, the message usually includes resource configuration information (for example, represented as zeroTxPowerResourceConfigList) and subframe configuration information (for example, represented as zeroTxPowerSubframeConfig).

Optionally, the message sent in step 311 may further include cell identification information about the ZP CSI RS resources of the serving base station 1, which is for example, but not limited to, a cell ID and a virtual cell ID. Alternatively, the cell identification information about the ZP CSI RS resources also may be associated with the cell identification information about the NZP CSI RS resources and thus be uniquely determined, so that the cell identification information about the ZP CSI RS resources can be omitted.

Optionally, the message sent in step 311 further includes effective time of the configuration information about the ZP CSI RS resources.

After successfully receiving and accepting the configuration information from the serving base station 1, the cooperating base station 2 returns an acknowledgment (Ack) message in step 321.

If the serving base station 1 receives the acknowledgment message from the cooperating base station 2, the serving base station 1 performs configuration according to the desired ZP CSI RS resources, and updates a CoMP Measurement Set correspondingly, and the updated CoMP Measurement Set can be notified to the user terminal 4 via RRC signaling.

If the serving base station 1 does not receive the acknowledgment message from the cooperating base station 2 within a predetermined time or receives a receive failure message from the cooperating base station 2, the serving base station 1 can re-send the message sent in step 311.

The messages from the serving base station 1 used to indicate the desired NZP CSI RS resources and indicate the desired ZP CSI RS resources can be sent separately, or be combined in one message and sent together. Correspondingly, reply messages from the cooperating base station 2 may be sent separately or combined in one message and sent together.

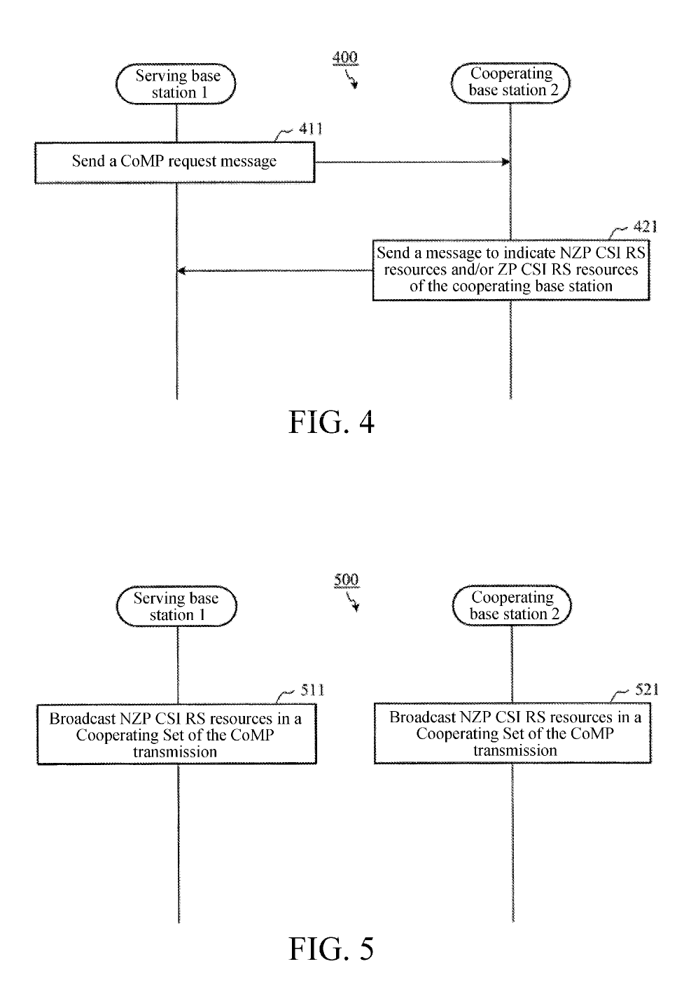

FIG. 4 is a flow diagram showing a method 400 for CoMP transmission that involves a serving base station 1 and a cooperating base station 2 according to an embodiment of the present invention. The method 400 includes step 411 at the serving base station 1 and step 421 at the cooperating base station 2.

Different from the previous methods 200 and 300, in step 411 of the method 400, the serving base station 1 simply sends a CoMP request message to the cooperating base station 2. The request message can request the cooperating base station 2 to configure at least two NZP CSI RS resources.

After receiving the CoMP request message from the serving base station 1, the cooperating base station 2 can select more suitable resources for the NZP CSI RS according to its own condition. Then, in step 421, a message is sent to the serving base station 1 to indicate NZP CSI RS resources and/or ZP CSI RS resources of the cooperating base station 2.

When receiving the message from the cooperating base station 2 indicating the NZP CSI RS resources and/or the ZP CSI RS resources of the cooperating base station 2, the serving base station 1 correspondingly updates a CoMP Measurement Set, and the updated CoMP Measurement Set can be notified to the user terminal 4 via RRC layer signaling.

Optionally, the message sent in step 421 may further include cell identification information and/or antenna port configuration information about the cooperating base station 2. The cell identification information is for example, but not limited to, a virtual cell ID. If the virtual cell ID of the cooperating base station 2 adopts a default value, the message does not necessarily include the virtual cell ID. If the serving base station 1 has known the antenna port configuration information about the cooperating base station 2 in advance, such information may be omitted in the message.

Optionally, the message sent in step 421 further includes effective time of the configuration information about the NZP CSI RS resources of the cooperating base station 2. If the effective time is not defined, the serving base station 1 will regard resources indicated by the cooperating base station 2 as being effective at all times, until the indication is updated next time.

FIG. 5 is a flow diagram showing a method 500 for CoMP transmission that involves a serving base station 1 and a cooperating base station 2 according to an embodiment of the present invention. The method 500 includes step 511 at the serving base station 1 and step 521 at the cooperating base station 2.

In step 511 and step 521, the serving base station 1 and the cooperating base station 2 broadcast NZP CSI RS resources in a Cooperating Set of the CoMP transmission respectively.

Then, the serving base station 1 can integrate all configuration information in the Cooperating Set, and updates a CoMP Measurement Set correspondingly, and the updated CoMP Measurement Set can be notified to the user terminal 4 via RRC signaling.

If configuration of the NZP CSI RS resources of either base station in the Cooperating Set changes, for example, the resources are added, removed or updated, it is necessary to update once again the NZP CSI RS resources in the Cooperating Set.

The above embodiments describe specific implementation of resource configuration when two base stations execute CoMP transmission. Under such teachings, persons skilled in the art could easily conceive of specific implementation of resource configuration when three or more base stations execute the CoMP transmission, which is not repeated herein.

Although different embodiments of the present invention have been elucidated and described, the present invention is not limited to these embodiments. Ordinal numbers such as “first” and “second” in the claims only play the role of differentiation, which does not mean that the corresponding members have any particular order or connection relationship. The technical features only appearing in some claims or embodiments do not mean that the technical features cannot be combined with other features in other claims or embodiments to achieve a new beneficial technical solution. Lots of modifications, changes, variations, replacements and equivalents without departing from the spirit and scope of the present invention as described in the claims are obvious for persons skilled in the art.

1. A method for a serving base station of Coordinated Multiple Point (CoMP) transmission, the method comprising:
sending a message to a cooperating base station of the CoMP transmission to indicate desired non-zero-power channel status information reference signal resources and/or zero-power channel status information reference signal resources.

2. The method according to claim 1, wherein the message comprises resource configuration information and subframe configuration information about the desired non-zero-power channel status information reference signal resources.

3. The method according to claim 2, wherein the message further comprises cell identification information and/or antenna port configuration information about the serving base station.

4. The method according to claim 2, wherein the message further comprises effective time of the resource configuration information and the subframe configuration information about the non-zero-power channel status information reference signal resources.

5. The method according to claim 1, wherein the message comprises zero transmission power resource configuration information and zero transmission power subframe configuration information about the desired zero-power channel status information reference signal resources.

6. The method according to claim 5, wherein the message further comprises cell identification information about the serving base station.

7. The method according to claim 5, wherein the message further comprises the zero transmission power subframe configuration information about the zero-power channel status information reference signal resources and effective time of the zero transmission power resource configuration information.

8. A method for a cooperating base station of Coordinated Multiple Point transmission, the method comprising:
sending a message to the serving base station to indicate non-zero-power channel status information reference signal resources and/or zero-power channel status information reference signal resources of the cooperating base station.

9. The method according to claim 8, further comprising:
receiving a request message about resource allocation of the CoMP transmission from the serving base station of the CoMP transmission.

10. The method according to claim 8, further comprising: receiving a message indicating desired non-zero-power channel status information reference signal resources and/or zero-power channel status information reference signal resources from the serving base station of the CoMP transmission.

11. The method according to claim 8, wherein the message comprises resource configuration information and subframe configuration information about the non-zero-power channel status information reference signal resources.

12. The method according to claim 11, wherein the message further comprises cell identification information and/or antenna port configuration information about the cooperating base station.

13. The method according to claim 11, wherein the message further comprises the subframe configuration information about the non-zero-power channel status information reference signal resources and effective time of the resource configuration information.

14. The method according to claim 8, wherein the message comprises resource configuration information and subframe configuration information about the zero-power channel status information reference signal resources.

15. The method according to claim 14, wherein the message further comprises cell identification information about the cooperating base station.

16. The method according to claim 14, wherein the message further comprises the subframe configuration information about the zero-power channel status information reference signal resources and effective time of the resource configuration information.

17. A method for a base station of Coordinated Multiple Point transmission, the method comprising:
broadcasting non-zero-power channel status information reference signal resources in a Cooperating Set of the CoMP transmission.

18. The method according to claim 17, wherein a serving base station of the CoMP transmission integrates all configuration information in the Cooperating Set, and updates a CoMP Measurement Set correspondingly.
